(19) United States
(12) Patent Application Publication
(10) Pub. No.: US 2013/0046448 A1
(43) Pub. Date: Feb. 21, 2013

(54) LAWN MOWER AND METHOD FOR CONTROLLING SELF-DRIVING OPERATIONS OF THE LAWN MOWER

(71) Applicant: POSITEC POWER TOOLS (SUZHOU) CO., LTD, Suzhou (CN)

(72) Inventors: Gongyuan FAN, Suzhou (CN); Fangshi LIU, Suzhou (CN); Qibin WANG, Suzhou (CN)

(73) Assignee: POSITEC POWER TOOLS (SUZHOU) CO., LTD, Suzhou (CN)

(21) Appl. No.: 13/656,128

(22) Filed: Oct. 19, 2012

Related U.S. Application Data
(63) Continuation of application No. PCT/CN2011/000703, filed on Apr. 21, 2011.

(30) Foreign Application Priority Data
Apr. 21, 2010 (CN) 201010158634.1
Apr. 21, 2010 (CN) 201010158635.6
Apr. 21, 2010 (CN) 201010158644.5

(51) Int. Cl. A01D 34/00; G06F 19/00

(52) U.S. Cl. 701/50; 56/10.7; 56/10.8; 56/11.8

(57) ABSTRACT

Lawn mower and method for controlling self-driving operations of the lawn mower wherein the lawn mower and method include a mower body, multiple wheels for supporting the mower body, and a drive motor for driving at least one wheel. Also disclosed is a controlling method for the mower including the following steps: an operator inputs predetermined parameters via am input device, a processor controls an execution circuit to control the drive motor to work according to the predetermined parameters, a sensor checks the actual operating parameters of the drive motor and feeds them back to the processor, the processor compares the actual operating parameters with the predetermined parameters to produce control signals, the execution circuit receives and processes the control signals, and regulates the actual operating parameters of the drive motor according to the predetermined parameters. The method enables the operation convenient and comfortable.

### BACKGROUND OF THE INVENTION

1. Technical Field

The invention relates to a lawn mower and a method for controlling the self-driving operation of the lawn mower.

2. Description of Related Art

Usually, outdoor gardening cutters such as a lawn mower are provided with an operating rod for pulling, and the upper operating rod is provided with a switch box and a control mechanism for convenient operation by the operator on the position close to the handle. The lawn mower moves on the ground and performs cutting by the thrust applied on the operating rod by the operator, and this kind of operation causes huge labor intensity. A lawn mower with a self-driving function is not required to be pushed by the operator with a large force. This kind of lawn mower has a drive motor to drive the front or the rear wheels, so the operator can control the running speed and the movement direction of the lawn mover by simply operating the control mechanism.

U.S. Pat. No. 5,442,901 discloses a speed regulation method for a self-driving lawn mower. According to this patent, the self-driving speed of the lawn mower is determined by the total amount of the thrust applied on the lawn mower by the operator and the output torque of the drive motor, while the adjustment of the output torque of the drive motor is independent from the control mechanism of the blade motor. The operator shall set the self-driving speed before the lawn mower performs the self-driving operation, and the self-driving speed of the lawn mower can be slightly adjusted by increasing the thrust or applying a pulling force. This kind of adjustment means has a certain effect where the lawn mower reduces the energy output, but fails to bring convenience to the operator because the speed cannot be regulated continuously.

CN utility model Pat. No. 200956739Y discloses a stepless speed regulating mechanism for a self-driving lawn mower, which comprises a tension bracket, a tension arm, a drive belt, a pulley and a speed pulley, wherein the tension arm is hinged with the tension bracket; one end of the tension arm is connected with a tension spring; the other end of the tension spring is connected to the tension bracket; the other end of the tension arm is connected with a speed regulating rope; at least one end of the tension arm is also connected with a rotary idler; the drive belt is sleeved on the speed pulley of the pulley, both located on one side of the tension arm and together with the rotary idler located on the same side; a first wheel disc and a second wheel disc of the speed pulley are sleeved in a spindle capable of transmitting torque and form a V-shaped belt trough such that the idler can press the drive belt by adjusting the speed regulating rope to change the actual pitch radius of the speed pulley and randomly adjust the self-driving speed without stop. This stepless speed regulating mechanism has the disadvantages of complicated structure, totally mechanical means, and poor stability.

### BRIEF SUMMARY OF THE INVENTION

The first objective of the present invention is to provide a lawn mower which has a simple operation interface, is flexibly operated and conveniently controlled, and has good human-machine functions.

The second objective of the present invention is to provide a highly stable and labor-saving lawn mower with human-machine functions.

The third objective of the present invention is to provide a lawn mower which is convenient to operate and stable in self-driving.

The fourth objective of the present invention is to provide a method for conveniently controlling the self-driving operations of a lawn mower in real time.

The fifth objective of the present invention is to provide method for conveniently controlling the constant-speed self-driving operations of a lawn mower in real time.

The first technology solution provided in this invention is: a lawn mower, comprising: a body; a cutting blade, arranged on the body; a plurality of wheels, supporting the body on the ground; a cutting motor, driving the cutting blade to rotate; a drive motor, driving at least one wheel to rotate; and an operating rod, connected with said body; said lawn mower is provided with a startup switch that controls said cutting motor and a driving switch that controls said drive motor, wherein said operating rod is movably provided with a control lever; and said startup switch and said driving switch are controlled to be triggered by the same control lever.

Compared with the prior arts, the present invention has the following advantages: A single control lever is used to selectively trigger and turn on the driving switch and startup switch in the switch box, so the operation is flexible and convenient; the self-driving speed of the lawn mower is controlled by operating the handle and the pivoting angle is specially set, so the operator works with a very small force, the operation is easy and the operating interface of the self-driving lawn mower is an ergonomic design.

The operating rod is provided with a switch box in which the startup switch and the driving switch are arranged.

The control lever is pivotally arranged in the switch box.

The control box is provided with a joint portion; and a key member comprises an action portion which is selectively connected with the joint portion of the switch box.

The control lever is provided with a block; the switch box is provided with a rotating member in an adjacent connection with the block and a slider in an adjacent connection with the rotating block.

The driving switch is provided with switch contacts, and the slider is selectively pressed against the switch contacts.

The startup switch is located above the driving switch; the driving switch is pivotally provided with a rocker member; the first arm of the rocker member is pressed against the key member; and the slider is selectively pressed against the second arm of the rocker member.

The operating rod is pivotally provided with a handle grip; the handle grip comprises a grip located above the switch box and the first and second connecting portions located on two sides of the grip; the switch box comprises the first and second connecting ends; the first and second connecting portions of the grip are fixedly connected with the first and second connecting ends of the switch box respectively.

The cutting motor and the drive motor may be the same motor.

The second technology solution provided in this invention is: a lawn mower, comprising: a mower body; a plurality of wheels, supporting the mower body; a drive motor, driving at least one wheel to rotate; and an operating rod, connected with the mower body, the lawn mower comprises a handle grip pivotally connected to the operating rod; the handle grip comprises at least two positions; when the handle grip is located at the first position, the self-driving speed of the lawn mower is zero; and when the handle grip is located at the second position, the self-driving speed of the lawn mower is larger than zero.

A drive clutch mechanism is arranged between the drive motor and the drive wheels; the drive clutch mechanism comprises a first clutch member and a second clutch member capable of being selectively engaged and disengaged; when the handle grip is located at the first position, the first and second clutch members are engaged, and the self-driving speed of the lawn mower is zero; and when the handle grip is located at the second position, the first and second clutch members are engaged, and the self-driving speed of the lawn mower is larger than zero.

The handle grip also comprises a third position; when the handle grip is located at the third position, the first and second clutch members are disengaged, and the self-driving speed of the lawn mower is zero.

Compared with the prior arts, the present invention has the following advantages: the handle can move among the initial position where the self-driving speed of the lawn mower is zero, the pivoting position where the self-driving speed is maximum, and the pivoting position where the transmission clutch mechanism is disengaged, so the operator can control the lawn mower to be in different states by simply operating the handle; due to the setting of the pivoting angle of the handle, the operator works with a very small force, the operation is easy, and the operating interface of the self-driving lawn mower is an ergonomic design.

The angle between the handle grip in the first position and the third position and the operating rod is an obtuse angle, the angle between the handle grip in the second position and the operating rod is a right angle.

The angle between the handle grip in the first position and the operating rod is approximately 97 degrees, the angle between the handle grip in the third position and the operating rod is approximately 105 degrees.

The drive motor is provided with a motor shaft; the first clutch member is slidably arranged at the moving gear of the motor shaft; and the second clutch member is rotationally arranged at the stationary gear of the motor shaft.

The lawn mower further comprises a switch box arranged at the operating rod; the switch box is provided with a driving switch and a control lever which is pivotally arranged in the switch box for starting the driving switch.

The switch box comprises a first connecting end and a second connecting end; the handle grip comprises a first connecting portion fixedly joined with the first connecting end of the switch box and a second connecting portion fixedly joined with the second connecting end of the switch box; the first connecting end of the switch box is provided with a first bracket fixedly connected with the operating rod; and the second connecting end of the switch box is provided with a second bracket fixedly connected with the operating rod.

The first bracket is pivotally provided with a supporting plate; and the supporting plate is provided with a stretching member which controls sliding of the moving gear.

The stretching member is a cable, the first connecting portion of the handle grip is provided with a pin, the first bracket is provided with an opening, the pin extend lengthways to pass through the opening and then is pressed against one side of the supporting plate adjacent to the operating rod.

The third technology solution provided in this invention is: a lawn mower, comprising: a mower body; a plurality of wheels, supporting the mower body; a drive motor, driving at least one wheel to rotate; an operating rod, connected with the mower body; and a control device, adjusting the self-driving operations of the lawn mower; the control device comprises a handle grip which is moveably arranged at the operating rod and can move between a first position where the rotating speed of the drive motor is zero and a second position where the rotating speed of the drive motor is larger than zero with respect to the operating rod, and an electronic control device which senses the position of the handle grip, detects the sensing result and adjusts the rotating speed of the drive motor according to the detection result.

Compared with the prior arts, the present invention has the following advantages: The lawn mower is provided with a handle which can move between the first position where the rotation speed of the drive motor is zero and the second position where the rotation speed of the drive motor is larger than zero, so the operator can conveniently continuously adjust the self-driving speed of the lawn mower during self-driving operation; corresponding to different handle positions, the electronic induction device can exactly detect and control the rotation speed of the drive motor such that the self-driving of the lawn mower is stable.

The handle grip is pivotally connected to the other end of the operating rod; and the electronic control device comprises an electronic induction device arranged between the handle grip and the operating rod.

The electronic induction device is a Hall sensor unit.

The electronic control device further comprises a processor electrically connected with the Hall sensor unit; and the processor is arranged at the mower body, receiving and processing signals output from the Hall sensor unit.

The electronic control device further comprises a speed sensor for detecting and adjusting the rotating speed of the drive motor.

The operating rod is provided with a switch box; the switch box is provided with a first connecting end and a second connecting end; the handle grip is provided with a first connecting portion and a second connecting portion; the first and second connecting portions of the handle grip are fixedly connected with the first and second connecting ends of the switch box respectively.

The Hall sensor unit comprises a first hall sensor unit fixedly arranged with respect to the operating rod, and a second hall sensor unit rotationally arranged with respect to the first hall sensor unit; and the first and second hall sensor units are received in the second connecting end of the switch box.

The first hall sensor unit is provided with a semiconductor member on the side with respect to the second hall sensor unit; the second hall sensor unit is provided with two magnet bodies on the side with respect to the first hall sensor unit; and the semiconductor member is located between the two magnet bodies.

The switch box is provided with a driving switch for controlling the drive motor inside; and the switch box is pivotally provided with a control lever for triggering the driving switch.

The control lever is provided with a grip; the handle grip is provided with a grip; and the grip of the handle grip and the grip of the control lever are located at the same height.

The fourth technology solution provided in this invention is: a method for controlling self-driving operations of a lawn mower; the lawn mower comprising: a mower body; a plurality of wheels, supporting the mower body; a drive motor, driving at least one wheel to rotate; the method comprises: an operator inputs preset parameters via an input device connected with the mower body; an electronic induction device electrically connected with the input device senses the change of the input device, converts the change of the input device into induction signals corresponding to the preset parameters, and outputs the induction signals to a processor; and the processor electrically connected with the input device controls an execution circuit so as to control the drive motor to work according to the preset parameters.

Compared with the prior art, the present invention has the following advantages:

the operator inputs the preset parameter via the input device; the electronic induction device can exactly sense the change of the input device, convert the change of the input device into an induction signal corresponding to the present parameter, and output the induction signal to the processor; then the processor controls the execution circuit so as to control the drive motor to work according to the present parameter; and thus, the lawn mower is conveniently controlled in real time.

The input device comprises a handle grip capable of being pivotally connected to the mower body, and the electronic induction device senses the displacement of the handle grip.

The electronic induction device senses the change of the input device in real time during the working process of the drive motor.

The preset parameters are preset speeds.

The fifth technology solution provided in this invention is: a method for controlling self-driving operations of a lawn mower, the lawn mower comprising: a mower body; a plurality of wheels, supporting the mower body; a drive motor, driving at least one wheel to rotate; the method comprises: an operator inputs preset parameters via an input device connected with the mower body; a processor electrically connected with an input device controls an execution circuit so as to control the drive motor to work according to the preset parameters; a sensor electrically connected with the processor detects the actual operating parameters of the drive motor and feeds the actual operating parameters to the processor; the processor compares the actual operating parameters and the preset parameters and generates control signals; and the execution circuit receives and processes the control signals and adjusts the actual operating parameters to equal to the preset parameters of the drive motor.

Compared with the prior art, the present invention has the following advantages: the operator inputs a preset parameter via the input device; the processor controls the execution circuit to control the drive motor to work according to the preset parameter; the sensor detects the actual operating parameter of the drive motor and feeds back the actual operating parameter to the processor; the processor compares the actual operating parameter and the preset parameter and generates the control signal; and the execution circuit receives and processes the control signal and adjusts the actual operating parameter of the drive motor to be equal to the preset parameter. In this way, the operating speed of the lawn mower is unchanged if the preset parameter input via the input device is unchanged. Therefore, regardless of whether there are obstacles during working or the ground is uneven, the operator can walk at a constant speed and is not required to adjust the running speed in person, so the operation is comfortable.

An electronic induction device is arranged between the input device and the processor, sensing the position of the input device, converting the position of the input device into the induction signals corresponding to the preset parameters, and outputting the induction signals to the processor.

The input device comprises a handle grip moveably connected to the mower body.

The input device is an electronic input device.

The preset parameters are preset speeds, and the actual operating parameters are actual running speeds.

### BRIEF DESCRIPTION OF THE SEVERAL VIEWS OF THE DRAWINGS

The invention is further described in details with the reference of embodiments.

FIG. 1 is a perspective schematic view of a self-driving lawn mower.

FIG. 2 is a lateral view of a self-driving lawn mower.

FIG. 3 is a partial enlarged view of an operation interface of a self-driving lawn mower.

FIG. 4 is a structural side view of an operation interface of a self-driving lawn mower.

FIG. 5 is a partial structural view of an operation interface of a self-driving lawn mower in a state that a switch box cover is removed.

FIG. 6 is a structural view of an operation interface of a self-driving lawn mower in a state that a switch box cover is removed.

FIG. 7 is another structural view of an operation interface of a self-driving lawn mower in a state that a switch box cover is removed.

FIG. 8 is a sectional view of FIG. 5 along the A-A direction.

FIG. 9 is a perspective schematic view of a drive structure of a self-driving lawn mower.

FIG. 10 is a partial enlarged view of FIG. 9, wherein a drive clutch mechanism is in a first state.

FIG. 11 is a partial enlarged view of FIG. 9, wherein a drive clutch mechanism is in a second state.

FIG. 12 is a partial enlarged view of a drive clutch mechanism in FIG. 9.

FIG. 13 is a sectional view of FIG. 5 along the B-B direction, wherein a handle grip is located at a first pivoting position.

FIG. 14 is a sectional view of FIG. 5 along the B-B direction, wherein a handle grip is located at an initial position.

FIG. 15 is a sectional view of FIG. 5 along the B-B direction, wherein a handle grip is located at a second pivoting position.

FIG. 16 is a schematic view of an electronic control device of a self-driving lawn mower.

### DETAILED DESCRIPTION OF THE INVENTION

The present invention discloses a self-driving lawn mower. The self-driving lawn mower is provided with a self-driving speed control device. An operator can control the self-driving speed of the lawn mower on the ground by adjusting the position of a handle grip of the lawn mower, so the operations are labor-saving and comfortable, and the lawn mower works stably. The following are detailed description

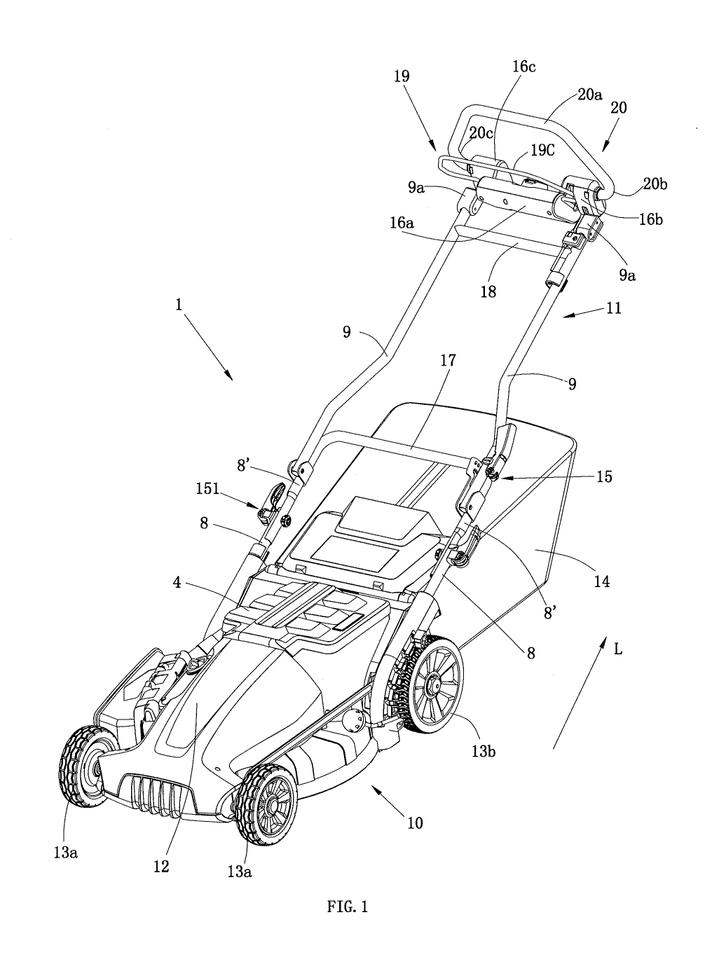

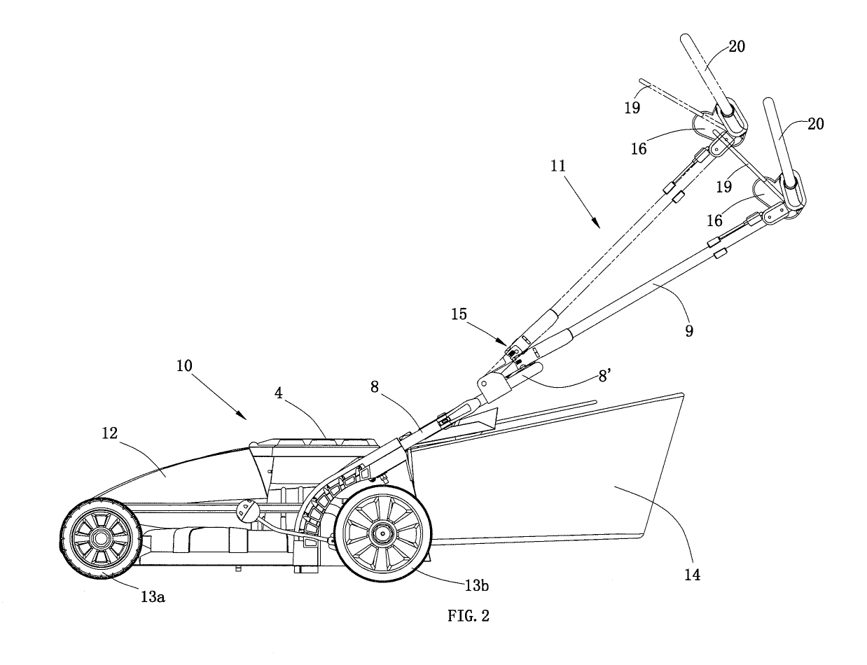

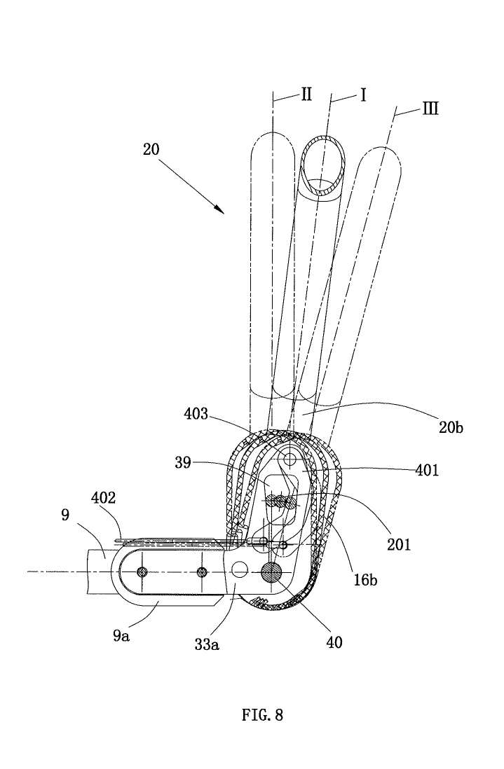

As shown in FIG. 1 and FIG. 2, a self-driving lawn mower 1 comprises a mower body 10, a pair of front wheels 13a and a pairs of rear wheels 13b (only one shown in the figure) supporting the mower body 10, an operating rod 11 on two sides of the mower body 10, and a grass collection box 14 located on the rear of the mower body 10, wherein the mower body 10 comprises a housing 12, a drive motor 6 (as shown in FIG. 8) arranged in the housing 12, a cutting motor, a cutting blade (not shown in the figure) driven to rotate by the cutting motor, and an electric source 4 supplying power for the cutting motor and drive motor 6. In this embodiment, a pair of rear wheels 13b is driven to rotate by the drive motor 6, and the electric source 4 for supplying power for the drive motor 6 and the cutting motor is a battery pack arranged in a receiving chamber formed in the housing 12. The operating rod 11 comprises a pair of lower operating rods 8 which are connected to two sides of the mower body 10 and are basically parallel to each other, and a pair of upper operating rods 9 respectively connected with the lower operating rods 8. The operating rod 11 longitudinally extends towards the rear upside (direction of the arrow L in the figure) from the mower body 10. To save the space for storing the lawn mower 1, the lower operating rods 8 in this embodiment are connected with the upper operating rods 9 via the middle operating rods 8′; a quick locking mechanism 151 is arranged between the middle operating rods 8′ and the lower operating rods 8; a transverse connecting portion 17 is arranged between the distal ends of the middle operating rods 8′; one of the lower operating rods 8 close to the connecting portion 17 is provided with an adjusting assembly 15; the upper operating rods 9 and the lower operating rods 8 are in connection pivotally; by the adjusting assembly 15, the upper operating rods 9 can be pivotally adjusted between a first position shown by a dotted line and a second position shown by a full line (as shown in FIG. 2) with respect to the lower operating rods 8 to meet the demands of different operators on operation height. The extension portions of the two upper operating rods 9 are parallel to each other. A transverse connecting rod 18 is arranged between the two parallel operating rods 9. A switch box 16 is arranged between the extension distal ends 9a of the upper operating rods 9. The switch box 16 is basically parallel to the transverse connecting rod 18. The switch box 16 comprises a body portion 16a and connecting ends 16b and 16c respectively arranged on two sides of the body portion 6a. A handle grip 20 held by an operator are fixedly joined with the first connecting end 16b and the second connecting end 16c of the switch box 16. The handle grip 20 is U-shaped, comprising a grip 20a located above the switch box 16, a first connecting portion 20b and a second connecting portion 20c respectively located on the two sides of the grip 20a. The first connecting portion 20b and the second connecting portion 20c are respectively correspondingly connected to the first and second connecting ends 16b and 16c of the switch box 16. A U-shaped control lever 19 located in front of the handle grip 20 is pivotally arranged on the switch box 16. The grip 19c of the U-shaped control lever 19 and the grip 20a of the U-shaped handle are basically located on the same height, so the operator is easy to grab and control the grip 19c of the U-shaped control lever 19 and the grip 20a of the U-shaped handle grip 20 together. In this embodiment, the control lever 19 may be a round rod made from a rigid material. The handle grip 20 may be a hollow steel pipe made from a rigid material; the diameter of the hollow steel pipe is bigger than that of the control lever; and the steel pipe is wrapped with a soft rubber coating such that the operator feels comfortable when holding the steel pipe.

In this embodiment, the drive motor 6 and the cutting motor may be one motor. Of course, the drive mechanism may be a motor or a gasoline motor, wherein the handle grip 20 may be shaped like an L, a ring, an oxhorn, or others; the control lever 19 may also be shaped according to the operation setting of the handle grip 20; the front wheel 13a and rear wheel 13b for supporting the mower body 10 shall have at least three wheels, thereof including at least one driven by the drive motor 6.

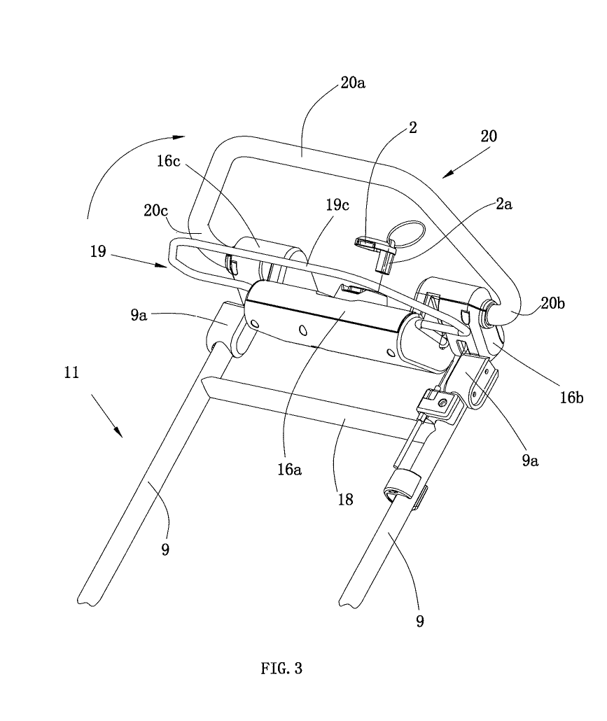

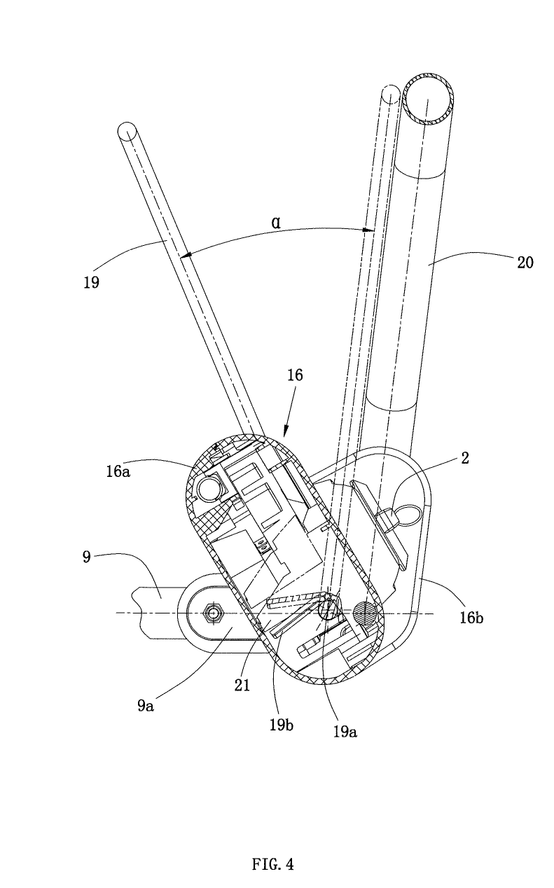

As shown in FIG. 3 and FIG. 4, a key member 2 is selectively jointed with the switch box 16 and comprises an action portion 2a which can be fixedly joined with the switch box 16 via a housing opening (not shown in the figure) of the switch box 16. The control lever 19 can pivotally rotate between a first position shown by the full line and a second position shown by a dotted line with respect to the handle grip 20; the angle α between the first position and the second position is about 30 degrees; and the control lever 19 is just pressed against the handle grip 20 when rotating to the second position. Reference FIG. 4, the control lever 19 has a shaft 19a extending to the main body 16a of the switch box 16. The shaft 19a is provided with a block 19b. When the control lever 19 pivotally rotates with respect to the switch box 16, the block 19b corresponding rotates between the first position shown by the full line and the second position shown by the dotted line. A rotating block 21 pressed against the block 19b moves to the second position shown by the dotted line by the thrush of the block 19b.

As shown in FIG. 5, the main body 16a of the switch box is provided with the block 19b, the rotating block 21, a slider 22, a driving switch 23 for controlling the self-driving of the lawn mower 1, a startup switch 25 for controlling the rotation of the blade, and a joint portion 28 for connecting with the key member 2 along the clockwise direction, wherein the startup switch 25 is located above the driving switch 23; the parts in the main body 16a of the switch box close to the first and second connecting ends 16b and 16c are respectively provided with restoration springs 26 of which the ends are pressed against the control lever 19; the shaft 19a of the control lever 19 has a central axis X. The lower side of the control lever 19 is provided with a shaft 40; the shaft 40 has a central axis Y; and the handle grip 20 can pivot around the shaft 40 with respect to the operating rod 11. The rotating block 21 is V-shaped and provided with a first arm 21a and a second arm 21b, and the first arm 21a thereof is pressed against the block 19b in a contact way. When the control lever 19 rotates around the shaft 19a toward the handle grip 20, the block 19b rotates and drives the V-shaped rotating block 21 to rotate around its pivot shaft 21c toward the direction indicated by the arrow R; one side of the second arm 21b of the V-shaped rotating block 21 is in adjacent to the slider 22, while the other side of the second arm 21b is pressed against the restoration spring 24, and the second arm 21b thrusts the slider 22 to slide in the switch box 16 along the direction indicated by the arrow S when the rotating block 21 pivots. When the control lever 19 rotates to the second position to be pressed against the handle grip 20, the rotating block 21 thrusts the slider 22 to move such that the lateral part of the slider 22 is collided with the switch contact 3a of the driving switch 23, and then the driving switch 23 is triggered and turned on.

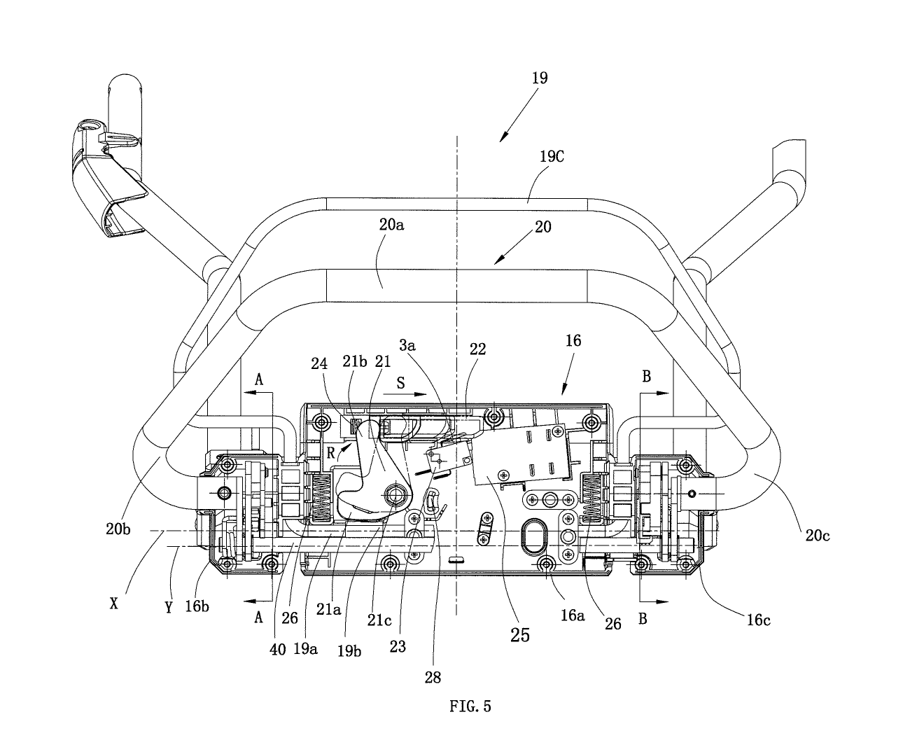

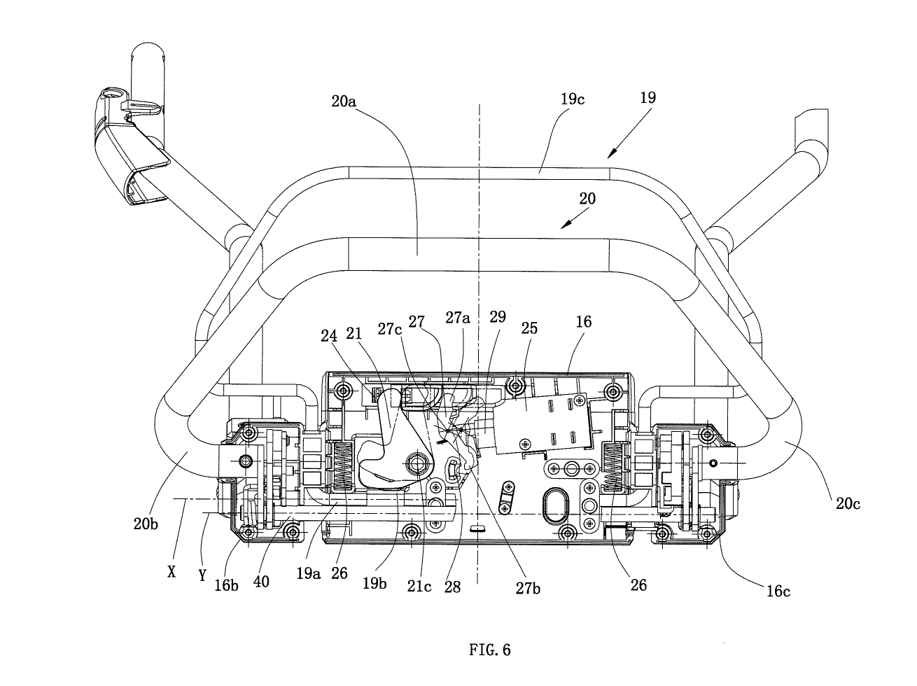

As shown in FIG. 6, the startup switch 25 located above the driving switch 23 is provided with an elastic actuating point 29; the top of the actuating point 29 is pivotally connected with a V-shaped rocker member 27; one arm 27a of the V-shaped rocker member 27 is adjacent to the slider 22, while the second arm thereof 27b is adjacent to a key joint portion 28; and generally, the second arm 27b inclines towards the startup switch 25 and is close to one side of the key joint portion 28 by the action of a spring member (not shown in the figure) of the V-shaped rocker member 27. When the action portion 2a of the key member 2 is connected with the key joint portion 28, the second arm 27b of the V-shaped rocker member 27 is pressed against the action portion 2a of the key member 2 in a contact way, and then the action portion 2a of the key member 2 limits the pivotal movement of the second arm 27b. At this moment, if the control lever 19 pivots to the second position to be pressed against the handle grip 20, the rotating block 21 will push the slider 22 to move, and then the slider 22 will push the first arm 27a of the V-shaped rocker member 27; because the second arm 27b of the V-shaped rocker member 27 is limited by the action portion 2a of the key member 2, the V-shaped rocker member 27 can resist the elastic action force of the actuating point 29 and move towards the startup switch 25 so as to trigger and turn on the startup switch 25 on condition that the two arms of the V-shaped rocker member 27.

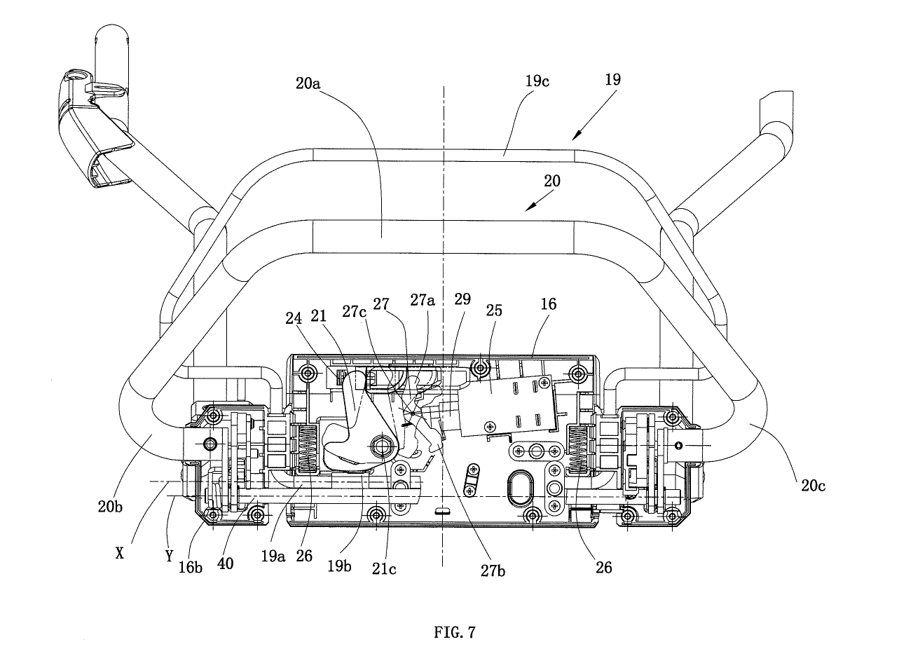

As shown in FIG. 7, when the action portion 2a of the key member 2 is not connected with the key joint point 28 of the switch box 16, the second arm 27b of the V-shaped rocker member 27 is free from the limit of the action portion 2a of the key member 2. When the first arm 27a of the V-shaped rocker member 27 is stressed, the V-shaped rocker member 27 rotates around its pivot shaft 27c from its initial position to a second position, and the actuating point 29 does not move such that the startup switch 25 cannot be turned on. To trigger and turn on the startup switch 25, the action portion 2a of the key member 2 shall be connected with the joint portion 28 of the switch box 16 in place, when the first arm 27a of the V-shaped rocker member 27 is stressed, the V-shaped rocker member 27 rotates around its pivot shaft 27c and move from its initial position to a second position shown by the dotted line in the switch box 16. The control lever 19 pivoted such that the driving switch 23 and the startup switch 25 can be turned at the same time. To stop the cutting operation or self-driving operation, the control lever 19 held in hand is released and can automatically return to the initial position away from the handle grip 20 by the action of the restoration spring 26, and then the self-driving switch 23 and the startup switch 25 both are turned off to stop the self-driving and cutting operations respectively. The stopping operation is very convenient. Of course, the operator can select to use the key member 2 or not according to the demands of the actual situation; when only selecting the self-driving mode, the operator only needs to pivoting the control lever 19; and when selecting the self-driving and cutting modes, the operator needs connect the key member 2 to the switch box 16 before operate the control lever 19.

As shown in FIG. 8, the handle grip 20 can pivot around the shaft 40 among the initial position I shown by the full line, the first operation position II and the second operation position III shown by the dotted line and with respect to the upper operating rods 9, wherein the first operation position II is a pivoting position close to the upper operating rod 9, and the second operation position III is a pivoting position away from the upper operating rod 9. The first connection portion 20b of the handle grip 20 is fixedly connected to the first connecting end 16b of the switch box 16. An L-shaped rigid bracket 33a is arranged between the distal end 9a of the operating rod and the first connecting portion 20b of the handle grip and fixedly connected to the distal end 9a of the operating rod via a fastener. A supporting plate 401 is pivotally connected to the rigid bracket 33a and can rotate around a shaft 403; the shaft 40 is connected to an angular point of the rigid bracket 33a and extends towards the main body 16a of the switch box. The handle grip 20 can pivot with respect to the shaft 40. The first connecting portion 20b of the handle grip is fixedly provided with a pin 201; the pin 201 passes through an opening 39 of the rigid bracket 33a to extend towards the main body 16a of the switch box and then is pressed against one side of the supporting plate 401; and the supporting plate 401 is connected with a stretching member which is usually a cable 402. One side of the supporting plate 401 is pressed against the pin 201 in a connective way close to the upper operating rod 9; when the handle grip 20 and the switch box 16 together pivot away from the upper operating rod 9 with respect to the shaft 40, the pin 201 pivots along with the handle grip 20 to push the supporting plate 401 to pivot away from the operating rod 9 with respect to the rigid bracket 33a and generates displacement, and then the cable 402 is stretched due to the rotation of the supporting plate 401. When the handle grip 20 pivots towards the first position close to the upper operating rod 9, the pin 201 deviates from one side of the supporting plate 401, and the supporting plate 401 does not rotate, which means that the cable 402 is not stretched. Besides, due to the shape of the opening 39, the pivotal movement of the pin 201 in the opening 39 is limited by the two lateral walls of the opening 39, which means that the maximum front inclination angle of the handle grip 20 relative to the operating rod 11, approximately 90 degrees and the maximum rear inclination angle, approximately 105 degrees, both are limited.

In this embodiment, the handle grip 20 is pivotally arranged with respect to the operating rod 11. Those skilled in the field also can assume that the handle grip 20 is slidably arranged with respect to the operating rod 11, and the operator can easily control the self-driving speed of the lawn mower on the ground by simply sliding and controlling the handle grip 20 on the operating rod 11.

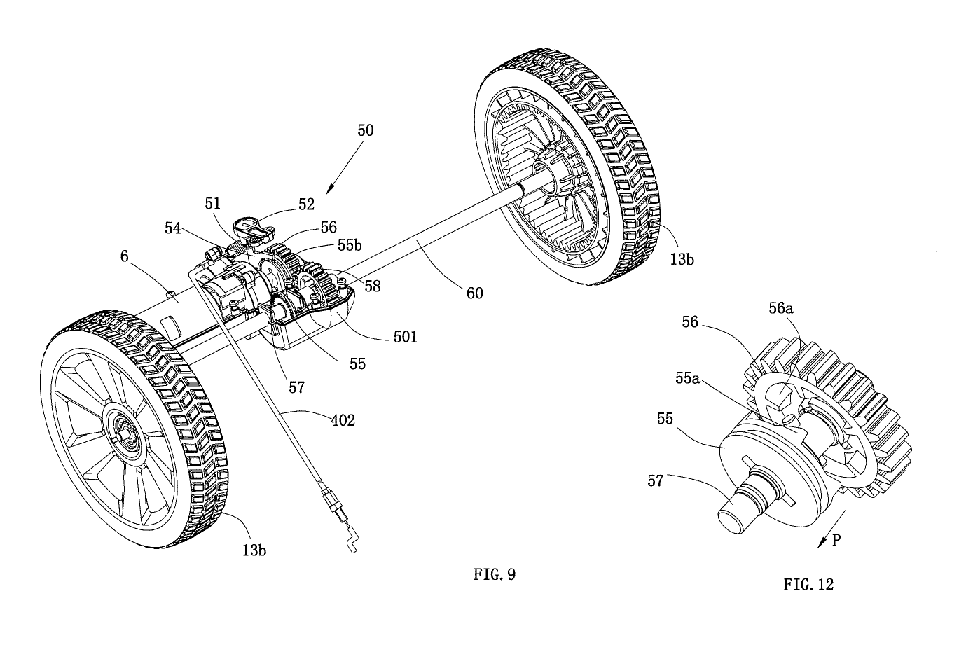

As shown in FIGS. 9, 10 and 11, the pair of rear wheels 13b of the lawn mower 1 is driving wheels; a transmission clutch mechanism 50 is arranged between the rear wheels 13b and the drive motor 6 and received in a gear box 501. The drive motor 6 is provided with a motor shaft 57; a moving gear 55 is slidably arranged on the motor shaft 57 and selectively engaged with and disengaged from a stationary gear 56; a drive gear 58 is fixed on a transmission shaft 60 and engaged with the stationary gear 56; a control device 52 with one end connected with the cable 402 is pivotally arranged on the gear box 501; a fork member 54 is fixedly connected with the lower end of the control device 52 and clamped with a groove 55b which is circumferentially formed on the surface of the moving gear 55; the control device 52 pivots by the stretching action of the cable 402 and meanwhile drives the fork member 54 to rotate; and then the fork member 54 drives the moving gear 55 to slide on the motor shaft 57.

Further as shown in FIGS. 8 and 11, when the handle grip 20 pivots towards the second operation position III away from the upper operating rod 9, the control device 52 pivots due to the stretching of the cable 402 and forces the fork member 54 to drive the moving gear 55 to move from the motor shaft 57 to the direction away from the stationary gear 56; the moving gear 55 is disengaged from the stationary gear 56; and then the rotation of the drive motor 6 cannot be transmitted to the rear wheels 13b via the transmission clutch mechanism 50. Therefore, when encountering an obstacle in the front, the lawn mower 1 can be easily pulled by the operator to move back as long as the operator holds the handle grip 20 to pivot towards the second operation position III to disengage the moving gear 55 from the stationary gear 56. When the handle grip 20 is located at the initial position I or pivots towards the first operation position II close to the upper operating rod 9, the control device 52 is located at the initial position thereof because the cable 402 does not stretch.

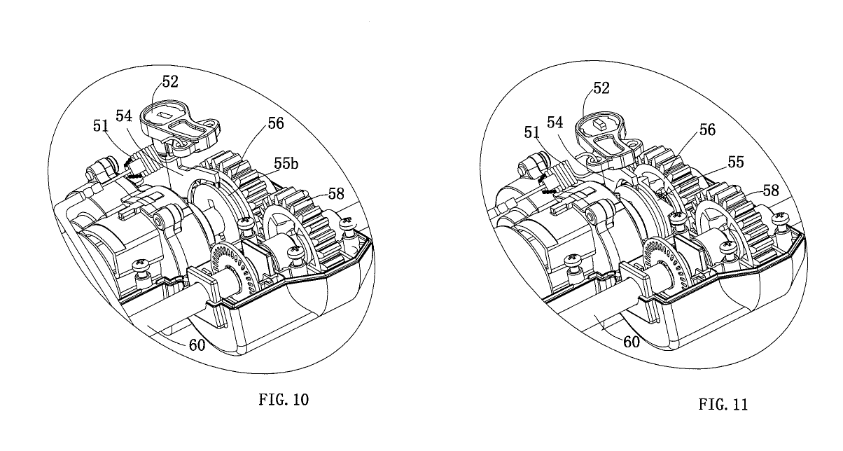

As shown in FIG. 10, the control device 52 is located at the initial position by the action of a spring member 51, the moving gear 55 and the stationary gear 56 are engaged at this moment; if the control lever 19 is pivoted to trigger and turn on the driving switch 23 and then together with the handle grip 20 pivoted toward the operating rod 11, the lawn mower is self-accelerated on the ground and the self-driving speed thereof increases along with the increase of the pivoting angle. Due to the above structure, the operator can control the transmission clutch mechanism 50 which is arranged between the drive motor 6 and the rear wheel 14b by stretching the cable 402 when rotating the handle grip 20. It should be noted that the self-driving speed of the lawn mower can be disposed as stepless speed adjustment or gear speed adjustment.

As shown in FIG. 12, in this embodiment, the stationary gear 56 and the motor shaft 57 are in a clearance fit; the stationary gear 56 rotates with respect to the motor shaft 57, but the axial movement of the stationary gear 56 is limited on the motor shaft 57. The engaged teeth of the stationary gear 56 and the moving gear 55 all are slope teeth 56a, 55a of which the slopes face each other. When the moving gear 55 and the stationary gear 56 are engaged, the slope tooth 55a of the moving gear 55 transmits the rotation torque to the slope tooth 56a of the stationary gear 56, and then the stationary gear 56 transmits the torque to the transmission shaft 60 via the drive gear 58. The moving gear 55 slides along the direction of the arrow P in the figure via the fork member 54 and the control device 52 with the action of the cable 402 so as to disengage from the stationary gear 56.

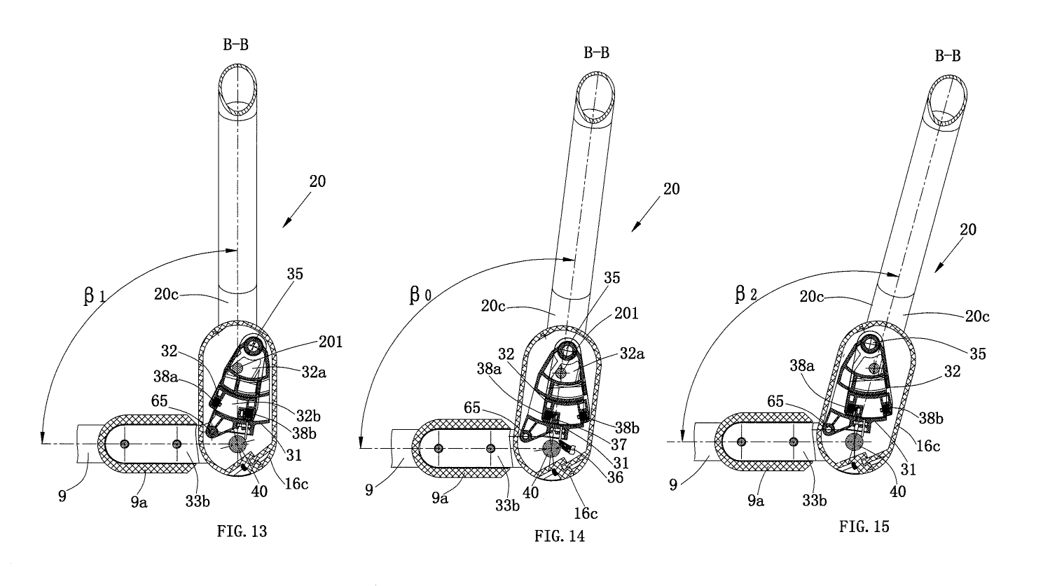

As shown in FIGS. 13, 14, 15 and 16, the self-driving lawn mower 1 further comprises a control device for adjusting the self-driving operations of the lawn mower 1. The control device comprises an input device and an electronic control device connected with the input device.

The operator can input the preset parameter via the input device. The input device may be a mechanical or electronic input unit. In this embodiment, the input device comprises a handle grip 20 moveably connected to the mower body 10.

The electronic control device comprises a processor 71 electrically connected with the input device and an execution circuit connected with the processor 71.

The processor 71 may be an analogue circuit or a digital circuit. In this embodiment, the processor 71 is the digital-circuit micro-programmed control unit (MCU) with features of simple structure and powerful functions.

The execution circuit under the control of the processor 71 is used for controlling the work of the drive motor 6. To realize the above function of the execution circuit, the primary way is to adjust the working energy applied onto the drive motor 6. In this embodiment, the execution circuit is a switch module comprising a transistor Q2 and a transistor driving circuit 73 for driving the transistor Q2 to work; the transistor driving circuit 73 receives signals sent from the processor 71 to adjust the working voltage applied on the drive motor 6 such that the drive motor 6 works according to the preset parameter.

The electronic control device also comprises a sensor. The sensor is used for detecting the actual operating parameters of the drive motor 6 and feeding back the actual operating parameters to the processor 71. The actual operating parameters of the drive motor 6 include the speed, torque, current, and voltage, etc., so the sensor can be correspondingly set to be a speed sensor, torque senor, current sensor, voltage sensor, etc. According to the demands of the invention the sensor is a speed sensor 72 in this embodiment.

The processor 71 compares the actual operating parameters with the preset parameter, generates control signals and outputs the control signals to the transistor driving circuit 73. The transistor driving circuit 73 receives and processes the control signals, and adjusts the actual operating parameters to equal to the preset parameter of the drive motor 6.

An electronic induction device is arranged between the input device and the processor 71 for sensing the position of the input device, converting the position of the input device into the induction signals corresponding to the preset parameter, and outputting the induction signals to the processor 71. The preset parameter may be the preset speed, preset toque, preset current, preset voltage, etc. In this embodiment, the present parameter is the preset speed.

In this embodiment, the electronic induction device is used for sensing the displacement of the handle grip 20. The second connecting portion 20c of the handle grip 20 is fixedly connected with the second connecting end 16c of the switch box 16 in which the electronic induction device is arranged.

The electronic induction device may be a hall sensor, a photosensitive sensor, a potentiometer or a differential transformer. In this embodiment, the electronic induction device is a hall sensor unit 30. The hall sensor unit 30 comprises a first hall sensor unit 31 and a second hall sensor unit 32 which are arranged in a jointed way, wherein the second hall sensor unit 32 is close to the handle grip 20, while the first hall sensor 31 is away from the handle grip 20; the first hall sensor 31 and the second hall sensor unit 32 are approximately sector-shaped and received in the second connecting end 16c of the switch box 16. A second rigid bracket 33b is fixed between the distal end 9a of the operating rod 9 and the second connecting portion 20c of the handle. The rigid bracket 33b is provided with a pin 35; the first hall sensor unit 31 and the second hall sensor unit 32 are respectively connected to the pin 35, and the first hall sensor unit 31 is fixed with the rigid bracket 33b by a screw 65 or in other fastening means, so the first hall sensor unit 31, the rigid bracket 33b and the upper operating rod 9 are relatively stationary. The second hall sensor unit 32 is provided with a first notch 32a on the end face directly facing the handle grip 20; a pin 201 which is fixedly connected to the handle grip 20 is partly received in the groove 32a; when the handle grip 20 is pivoted, the pin 35 is pivoted together with the handle grip 20 and rotates in the groove 32a; when the pin 32a rotates to the position to contact with the groove 32a, the second hall sensor unit 32 is driven to rotate together, which means that the second hall sensor unit 32 can rotate around the pin 35 with respect to the first hall sensor unit 31. The second hall sensor unit 32 is also provided with a second notch 32b on the end face directly facing the first hall sensor unit 31, and the two magnet bodies 38a and 38b are respectively arranged on two ends of the second notch 32b. The first hall sensor unit 31 is provided with a hall element 37 which is made from a semiconductor material and connected with an electric source 4 via a hall cable 36 (as shown in FIG. 14). The hall element 37 is just located between the two opposite magnet bodies 38a and 38b of the second hall sensor unit 32; when the second hall sensor unit 32 rotates with respect to the first hall sensor unit 31, the two magnet bodies 38a and 38b move with respect to the hall element 37, and then the two ends of the hall element 37 generate voltage change, namely the hall induction voltage. In this embodiment, the hall sensor unit 30 may be replaced by the electronic induction devices such as the potentiometer used in the industry.

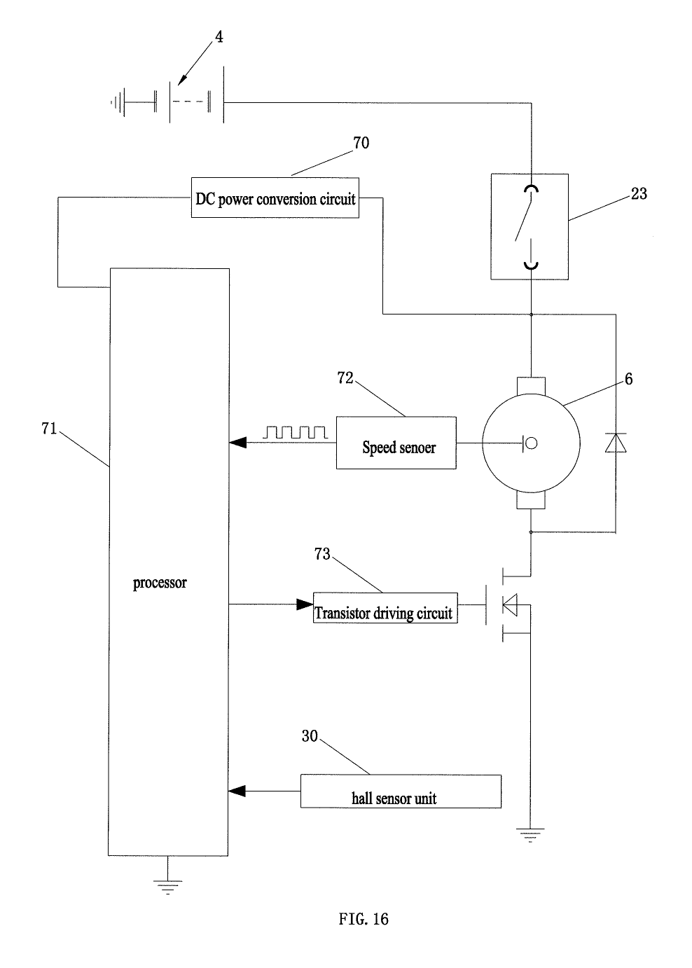

Further as shown in FIG. 16, when the driving switch 23 is turned on, the DC electric source 4 is introduced to a DC power conversion circuit 70 via the driving switch 23; the DC power conversion circuit 70 converts the high-voltage DC electric source into the low-voltage DC electric source to supply power for the related elements such as the processor 71 and the hall sensor unit 30.

When inputting the preset speed via the input device, the operator shall rotate the handle grip 20 first, and then the handle grip 20 drives the magnet bodies 38a and 38b to move so as to adjust the position of the hall element 37 relative to the magnet bodies 38a and 38b. The hall sensor unit 30 outputs the corresponding induction voltage signal to the processor 71 according to the position of the hall element 37 relative to the magnet bodies 38a and 38b. After receiving the induction voltage signal, the processor 71 can judge the preset speed input by the user according to the induction voltage signal and generate the corresponding PWM signals according to the preset speed input by the user to control the working state of the transistor Q2 via the transistor driving circuit 73, thus adjusting the working speed of the drive motor 6. Meanwhile, the speed sensor 72 detects the actual operating speed of the drive motor 6 and transmits the actual operating speed to the processor 71. The processor 71 compares the actual operating speed of the drive motor 6 with the preset speed input by the operator, and generates corresponding PWM signals according to the comparison result to control the operation of the execution unit such that the current speed of the drive motor 6 is matched with the speed set by the user. When the actual operating speed of the drive motor 6 is higher than the preset speed input by the operator, the working voltage applied onto the drive motor 6 can be reduced by lowering the duty ratio of the PWM signal; when the actual operating speed of the drive motor 6 is lower than the preset speed input by the operator, the working voltage applied to the drive motor 6 can be increased by increasing the duty ratio of the PWM signal; and when the actual operating speed of the drive motor 6 is equal to the preset speed input by the operator, the working voltage applied onto the drive motor 6 is kept by maintaining the duty ratio of the PWM signal.

The processor 71 senses the preset speed input by the operator via the electronic induction device, and generates corresponding control signal to the execution unit according to the preset speed to control the operating speed of the drive motor 6; meanwhile, the processor 71 detects the operating speed of the drive motor 6 via the sensor, compares the operating speed with the preset speed, and generates corresponding signal to the execution unit according to the comparison result to realize closed-loop control over the speed of the drive motor 6 such that the operating speed of the drive motor 6 is finally equal to the preset speed input by the operator.

In this way, the running speed of the lawn mower is unchanged if the position of the handle grip 20 is not changed. The walking speed of the operator has influence on the change of the handle position. When the operator wants to walk fast, the lawn mower can be accelerated by simply moving the handle grip 20 forward; when the operator wants to walk slowly, the lawn mower can be decelerated by simply moving the handle grip 20 backward; and when the operator wants to walk at a constant speed, the position of the handle grip 20 is only required to be maintained. Therefore, regardless of whether there are obstacles during working or if the ground is uneven, the operator can walk at a constant speed and is not required to adjust the running speed in person, so the operation is comfortable.

It should be noted that, the operator may also input the preset parameter via electronic input units such as a touch screen or keys, and in such cases, the invention can be realized without an electronic induction device. When the preset parameter input by the operator via the input device is the preset current, the preset voltage, or the preset torque, the processor 71 detects the corresponding preset parameter input by the operator and sends corresponding control signals to the execution unit according to the present parameter to control the operating parameter of the drive motor 6; meanwhile the processor 71 detects the operating parameter of the drive motor 6 via the sensor, compares the operating parameter and the preset parameter, and sends corresponding control signal to the execution unit according to the comparison result to realize closed-loop control over the operating parameter of the drive motor 6 such that the operating parameter of the drive motor 6 is finally equal to the preset parameter input by the operator. The detailed execution is similar to the closed-loop control over the operating speed of the drive motor 6 and therefore is omitted here.

With the above control device, the following method can be adopted to control the self-driving operations of the lawn mower. The method comprises: an operator inputs a preset parameter via an input device; an electronic induction device electrically connected with the input device senses the change of the input device, converts the change of the input device into an induction signal corresponding to the preset parameter, and outputs the induction signal to a processor 71; and the processor 71 controls an execution circuit so as to control the drive motor 6 to work according to the preset parameter. Thus, the lawn mower can change in real time according to the preset parameter input by the operator.

In this embodiment, the input device comprises a handle grip 20 pivotally connected to a mower body 10, and the electronic induction device senses the position change of the handle grip 20. Besides, the electronic induction device senses the change of the input device in real time in the working process of the drive motor 6.

With the above control device, the following method can be adopted to control the self-driving operations of the lawn mower. The method comprises: an operator inputs a preset parameter via an input device; a processor 71 controls an execution circuit to control a drive motor 6 to work according to the preset parameter; a sensor detects the actual operating parameter of the drive motor 6 and feeds back the actual operating parameter to the processor 71; the processor 71 compares the actual operating parameter and the preset parameter and generates a control signal; and the execution circuit receives and processes the control signal and adjusts the actual operating parameter of the drive motor 6 to be equal to the preset parameter. Thus, the lawn mower can run at a constant speed according to the preset parameter input by the operator, and the operation is comfortable.

In this embodiment, the input device is a mechanical input device; an electronic induction device is arranged between the input device and the processor 71 for sensing the position of the input device, converting the position of the input device into an induction signal corresponding to the preset parameter and outputting the induction signal to the processor.

In use, the control lever 19 can be rotated to turn on the driving switch 23 first such that the self-driving control circuit of the lawn mower closes; then the handle grip 20 is held to pivot together with the control lever 19 towards the upper operating rod 9 such that the lawn mower is self-accelerated on the ground correspondingly according to the increase of the pivoting angle. As shown in FIGS. 8 and 13, when the handle grip 20 is pivoted to the first operation position II which is approximately vertical to the upper operating rod 9, which means that angle β1 between the central axes of the handle grip 20 and the distal end 9a of the operating rod is 90 degrees, the lawn mower runs at the maximum self-driving speed. Of course, the maximum self-driving speed is the optimal speed for realizing the best cutting effect that is designed on the basis of comprehensively taking the lawn and ground conditions into consideration, so the situation that the walking speed of the operator fails to catch up the self-driving speed in the normal operating process is avoided; when the cutting operation is carried out at the maximum speed, the direction of the action force applied onto the handle grip 20 by the operator is approximately parallel to the operating rod 11 because the handle grip 20 is approximately vertical with respect to the upper operating rod 9; the action force applied on the handle grip 20 is transmitted to the mower body 10 via the upper operating rod 9; the extension line of the upper operating rod 9 in the direction of the action force is approximately located nearby the mass centre of the mower body 10, so there is no an extra force to make the mower body 10 able to turn around the front wheel 13a or the rear wheel 13b. Therefore, the lawn mower is stably propelled and meets the ergonomic requirements, and the operator feels comfortable and easy during the operation. As shown in FIGS. 8 and 14, when the handle grip 20 is controlled to return to the initial position I, the angle β0 between the central axes of the handle grip 20 and the distal end 9a of the upper operating rod is approximately 97 degrees, and then the speed of the drive motor 6 is zero, which means that the self-driving speed of the lawn mower is zero; besides, the cable 402 is not stretched at this position, so the transmission clutch mechanism 50 is engaged. As shown in FIGS. 8 and 15, when the handle grip 20 pivots from the initial position I towards the second operation position III away from the direction of the upper operating rod 9, the maximum angle β2 between central axes of the handle grip 20 and the distal end 9a of the upper operating rod is approximately 105 degrees, the cable 402 is stretched and then the transmission clutch mechanism 50 of the lawn mower is disengaged such that the lawn mower can be easily pulled back by the operator.

What is claimed is:

1. A lawn mower, comprising:
a body;
a cutting blade, arranged on the body;
a plurality of wheels, supporting the body on the ground;
a cutting motor, driving the cutting blade to rotate;
a drive motor, driving at least one wheel to rotate;
and an operating rod, connected with said body;
wherein said lawn mower is provided with a startup switch that controls said cutting motor and a driving switch that controls said drive motor, said operating rod is movably provided with a control lever; and said startup switch and said driving switch are controlled to be triggered by the same control lever.

2. The lawn mover according to claim 1, wherein said operating rod is provided with a switch box in which said startup switch and said driving switch are arranged.

3. The lawn mover according to claim 2, wherein said control lever is pivotally arranged in said switch box.

4. The lawn mover according to claim 3, wherein said control box is provided with a joint portion; and a key member comprises an action portion which is selectively connected with said joint portion of said switch box.

5. The lawn mover according to claim 4, wherein said control lever is provided with a block; said switch box is provided with a rotating member in an adjacent connection with the block and a slider in an adjacent connection with said rotating block.

6. The lawn mover according to claim 5, wherein said driving switch is provided with switch contacts, and said slider is selectively pressed against said switch contacts.

7. The lawn mover according to claim 6, wherein said startup switch is located above said driving switch; said driving switch is pivotally provided with a rocker member; the first arm of said rocker member is pressed against said key member; and said slider is selectively pressed against the second arm of said rocker member.

8. The lawn mover according to claim 7, wherein said operating rod is pivotally provided with a handle grip; said handle grip comprises a grip located above said switch box and the first and second connecting portions located on two sides of said grip; said switch box comprises the first and second connecting ends; the first and second connecting portions of said grip are fixedly connected with the first and second connecting ends of the switch box respectively.

9. The lawn mover according to claim 1, wherein said cutting motor and said drive motor may be the same motor.

10. A lawn mower, comprising:
a mower body;
a plurality of wheels, supporting the mower body;
a drive motor, driving at least one wheel to rotate;
and an operating rod, connected with said mower body;
wherein said lawn mower comprises a handle grip pivotally connected to the operating rod; said handle grip comprises at least two positions; when the handle grip is located at the first position, the self-driving speed of the lawn mower is zero; and when the handle grip is located at the second position, the self-driving speed of the lawn mower is larger than zero.

11. The lawn mower according to claim 10, wherein a drive clutch mechanism is arranged between the drive motor and the drive wheels; said drive clutch mechanism comprises a first clutch member and a second clutch member capable of being selectively engaged and disengaged; when the handle grip is located at the first position, the first and second clutch members are engaged, and the self-driving speed of the lawn mower is zero; and when the handle grip is located at the second position, the first and second clutch members are engaged, and the self-driving speed of the lawn mower is larger than zero.

12. The lawn mower according to claim 11, wherein said handle grip also comprises a third position; when the handle grip is located at the third position, the first and second clutch members are disengaged, and the self-driving speed of the lawn mower is zero.

13. The lawn mower according to claim 11, wherein said drive motor is provided with a motor shaft; the first clutch member is slidably arranged at the moving gear of the motor shaft; and the second clutch member is rotationally arranged at the stationary gear of the motor shaft.

14. The lawn mower according to claim 12, wherein said lawn mower further comprises a switch box arranged at the operating rod; the switch box is provided with a driving switch and a control lever which is pivotally arranged in the switch box for starting said driving switch.

15. The lawn mower according to claim 14, wherein said switch box comprises a first connecting end and a second connecting end; said handle grip comprises a first connecting portion fixedly joined with the first connecting end of the switch box and a second connecting portion fixedly joined with the second connecting end of the switch box; the first connecting end of the switch box is provided with a first bracket fixedly connected with the operating rod; and the second connecting end of the switch box is provided with a second bracket fixedly connected with the operating rod.

16. The lawn mower according to claim 15, wherein said first bracket is pivotally provided with a supporting plate; and the supporting plate is provided with a stretching member which controls sliding of the moving gear.

17. A lawn mower, comprising:
a mower body;
a plurality of wheels, supporting the mower body;
a drive motor, driving at least one wheel to rotate;
an operating rod, connected with said mower body;
and a control device, adjusting the self-driving operations of the lawn mower;
wherein said control device comprises a handle grip which is moveably arranged at the operating rod and can move between a first position where the rotating speed of the drive motor is zero and a second position where the rotating speed of the drive motor is larger than zero with respect to the operating rod, and an electronic control device which senses the position of the handle grip, detects the sensing result and adjusts the rotating speed of the drive motor according to the detection result.

18. The lawn mower according to claim 17, wherein said handle grip is pivotally connected to the other end of the operating rod; and the electronic control device comprises an electronic induction device arranged between the handle grip and the operating rod.

19. The lawn mover according to claim 18, wherein said electronic induction device is a Hall sensor unit.

20. The lawn mower according to claim 19, wherein said electronic control device further comprises a processor electrically connected with the Hall sensor unit; and said processor is arranged at the mower body, receiving and processing signals output from the Hall sensor unit.

21. The lawn mower according to claim 20, wherein said electronic control device further comprises a speed sensor for detecting and adjusting the rotating speed of the drive motor.

22. The lawn mover according to claim 21, wherein said operating rod is provided with a switch box; the switch box is provided with a first connecting end and a second connecting end; said handle grip is provided with a first connecting portion and a second connecting portion; the first and second connecting portions of said handle grip are fixedly connected with the first and second connecting ends of the switch box respectively.

23. The lawn mower according to claim 22, wherein said Hall sensor unit comprises a first hall sensor unit fixedly arranged with respect to the operating rod, and a second hall sensor unit rotationally arranged with respect to the first hall sensor unit; and the first and second hall sensor units are received in the second connecting end of said switch box.

24. The lawn mower according to claim 23, wherein said first hall sensor unit is provided with a semiconductor member on the side with respect to the second hall sensor unit; the second hall sensor unit is provided with two magnet bodies on the side with respect to the first hall sensor unit; and the semiconductor member is located between the two magnet bodies.

25. The lawn mower according to claim 24, wherein said switch box is provided with a driving switch for controlling the drive motor inside; and said switch box is pivotally provided with a control lever for triggering said driving switch.

26. The lawn mower according to claim 25, wherein said control lever is provided with a grip; the handle grip is provided with a grip; and the grip of said handle grip and the grip of said control lever are located at the same height.

27. A method for controlling self-driving operations of a lawn mower, said lawn mower comprising:
a mower body;
a plurality of wheels, supporting the mower body;
a drive motor, driving at least one wheel to rotate;
wherein said method comprises:
an operator inputs preset parameters via an input device connected with said mower body;
an electronic induction device electrically connected with the input device senses the change of the input device, converts the change of the input device into induction signals corresponding to said preset parameters, and outputs said induction signals to a processor; and the processor electrically connected with the input device controls an execution circuit so as to control the drive motor to work according to the preset parameters.
